(19) United States
(12) Patent Application Publication
(10) Pub. No.: US 2016/0071199 A1
(43) Pub. Date: Mar. 10, 2016

(54) SYSTEM AND METHOD FOR VIDEO RENTAL

(71) Applicant: THOMSON LICENSING, Issy les Moulineaux (FR)

(72) Inventor: Boris TEKSLER, Los Altos, CA (US)

(21) Appl. No.: 14/833,695

(22) Filed: Aug. 24, 2015

Related U.S. Application Data
(60) Provisional application No. 62/048,398, filed on Sep. 10, 2014.

(51) Int. Cl. G06Q 30/06

(52) U.S. Cl. CPC G06Q 30/0645

(57) ABSTRACT

A method of displaying a media item sub-rental opportunity to multiple users includes receiving information concerning original rental time periods for a plurality of media items, receiving a selection of one of the plurality of media items, displaying sub-rental time slots within an original rental time period for the selected media item, and receiving a selection of an sub-rental time slot. A media device then enables online access to the selected media item in the selected sub-rental time slot and provides a display of the selected media item during the selected sub-rental time slot.

### FIELD

The present invention relates to the distribution of video content, and in particular, is related to a method of re-distributing video content within a rental period.

### BACKGROUND

The on-line digital media rental market is very price competitive. Digital media renters such as RedBox™ purchase a digital media item, such as a DVD disk, and rent it out multiple times to secure revenue. Digital media includes media items such as movies, television program episodes, homemade and professionally produced training and entertainment videos, video games, and the like. However, some digital media items are not available for outright purchase. Some premium subscription services can feature limited distribution digital media items for rent for which no bulk purchase media item is available. Thus, these premium subscription services have rental contracts directly with digital media owners, such as studios. The digital media studios may have terms that specify a pre-defined rental period and price for each digital media item sourced from the studio. There is a desire to achieve secondary rental revenues using these digital media items. A method and apparatus is needed to address secondary rental for digital media items that are only available via premium sources, such as studios and other production houses.

### SUMMARY

This summary is provided to introduce a selection of concepts in a simplified form as a prelude to the more detailed description that is presented later. The summary is not intended to identify key or essential features of the invention, nor is it intended to delineate the scope of the claimed subject matter.

A method and apparatus for displaying a media item sub-rental opportunity to multiple users includes receiving information concerning original rental time periods for a plurality of media items. The original rental time period of any of the media items can be divided into multiple sub-rental time slots where a user/viewer has a fixed time period in which to access and view a selected one of the media items. The apparatus receives a selection of one of the plurality of media items, displays sub-rental time slots within an original rental time period that are available for the selected media item, and receives a selection of a sub-rental time slot from a user. The apparatus then enables access to the selected media item in the selected sub-rental time slot and provides a display of the selected media item during the selected sub-rental time slot.

Additional features and advantages of the invention will be made apparent from the following detailed description of illustrative embodiments which proceeds with reference to the accompanying figures. It should be understood that the drawings are for the purpose of illustrating the inventive concepts and are not necessarily the only possible implementations of the inventive concepts.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention. In the drawings, like numbers represent similar elements.

FIG. 1 illustrates an example system block diagram and environment in which the inventive arrangement may reside;

FIG. 2 illustrates an example sub-rental opportunity within an original rental time period corresponding to the inventive arrangement;

FIG. 3 illustrates an example sub-rental opportunity selection user interface corresponding to the inventive arrangement;

FIG. 4 depicts an example flow diagram of the inventive arrangement; and

FIG. 5 illustrates an example media device block diagram containing aspects of the inventive arrangement.

### DETAILED DISCUSSION OF THE EMBODIMENTS

In the following description of various illustrative embodiments, reference is made to the accompanying drawings, which form a part thereof, and in which is shown, by way of illustration, how various embodiments in the invention may be practiced. It is to be understood that other embodiments may be utilized and structural and functional modification may be made without departing from the scope of the present invention.

In accordance with an aspect of the invention, an original rental period for a digital media item is identified and used as a base time period to establish sub-rental time periods. The original rental time period is divided into multiple sub-rental time intervals which allows multiple renting opportunities for the digital media item. Aspects of the invention utilize the multiple sub-rental time periods to rent the digital media item to multiple users while maintaining the integrity of the original rental time period.

An apparatus has a user interface that allows a user to select a media item, such as a movie, to be digitally rented for a limited time slot period, wherein the time slot is slightly longer than the length of the movie. The user/renter can select the media item and the available time slots using the interface. The advantage to the customer is a lower media item rental price.

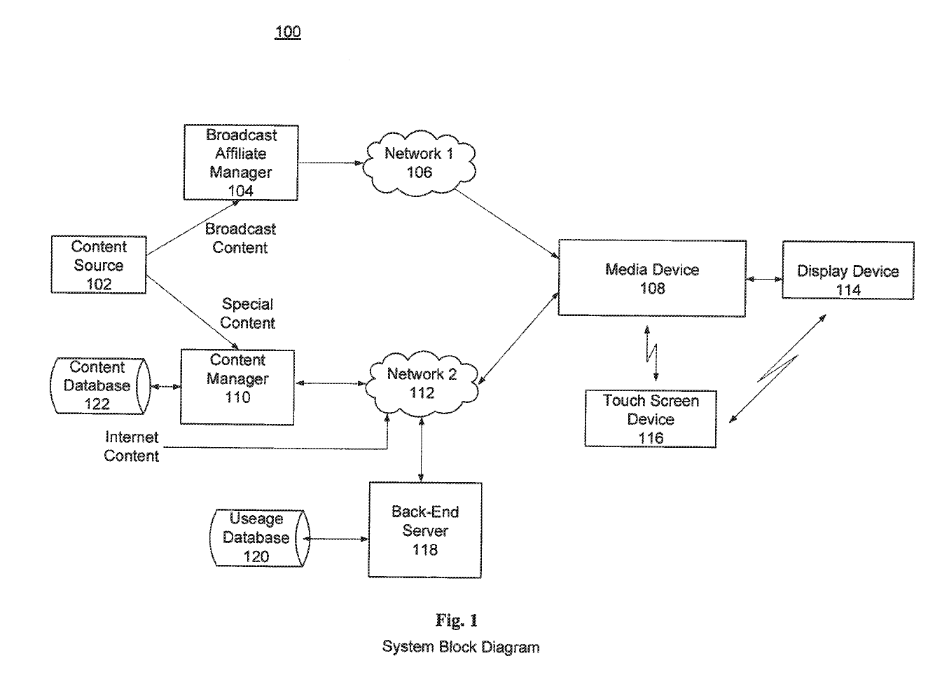

Initially, a system environment is provided in which the invention may reside. FIG. 1 is a block diagram of an embodiment of a system 100 for delivering a media item, (i.e. digital content), to a home or end user. Here, the term media item is digital content available for viewing, in a preferred embodiment, via a subscription type service using a display under control of a media device. Normally, the subscription service would be an online service accessible via the Internet or other available digital network. The media item can be digital content of any type, such as a movie having audio and video, a game, an e-book, an audio file, or any other type of single or multimedia digital content item. For compact reference, digital content available from such a service will be termed a media item and is synonymous with content, digital media, digital content, media item, media content item, and media item asset. The media item originates from a content source 102, such as a movie studio or other production house. This content source 102 can dictate the terms of an original rental time period for the media item. For purposes of the current inventive arrangement, it is assumed that the rental terms include a temporary availability of the digital item. That is, the media item is available as a rental item for fixed amount of time and is not available as an article for purchase.

In FIG. 1, media items can be supplied in at least one of two forms. One form can be a broadcast form of content. The broadcast content is provided to the broadcast affiliate manager 104, which is typically a broadcast service, such as the American Broadcasting Company (ABC), National Broadcasting Company (NBC), Columbia Broadcasting System (CBS), etc. The broadcast affiliate manager can collect and store the media item, and can schedule delivery of the media item over a delivery network, shown as delivery network 1 (106). Delivery network 1 (106) can include satellite link transmission from a national center to one or more regional or local centers. Delivery network 1 (106) can also include local media item delivery using local delivery systems such as over the air broadcast, satellite broadcast, or cable broadcast. The locally delivered media items is provided to a media device 108 in a user's home as a list, where the list of media items that is available will subsequently be searched by the user. It is to be appreciated that the media device 108 can take many forms and can be embodied as a set top box, television, digital video recorder (DVR), a gateway, a modem, any combination thereof, and the like. Further, the media device 108 can act as entry point, or gateway, for a home network system that includes additional devices configured as either client or peer devices in the home network.

One form of media item from content source 102 may be referred to as special content. In the context of the present invention, special content can include content delivered as a media item for an original rental time period that is a length of time that exceeds the actual play duration of the media item. In a preferable embodiment, the original rental period exceeds the actual play duration of the media item by at least a factor of 10. An example would be a media item such as a movie having a play duration of two hours and an original rental period of at least 20 hours. Longer original rental periods are easily accommodated. The media item may include pay-per-view type of rental, such as movies, video games, or other video elements. In many cases, the special content can be content that would normally be requested by a user. However, in this instance, the special content, with its original rental period that is much longer than needed to play the media item may be selected by and delivered to the content manager 110. In one embodiment, the media item having an original long duration rental period may be provided to the content manager 110 by the content source 102 under an original, long duration rental period agreement with a content provider. In other or combined embodiments, the content manager 110 can be a service provider, such as an Internet website, affiliated, for instance, with a content provider, broadcast service, or delivery network service. The content manager 110 can also incorporate Internet content into the delivery system. The content manager 110 can deliver the content to the user's media device 108 over a separate delivery network, delivery network 2 (112). Delivery network 2 (112) can include high-speed broadband Internet type communications systems. In alternate embodiment of FIG. 1, the content from the broadcast affiliate manager 104 can also be delivered using all or parts of delivery network 2 (112) and content from the content manager 110 can be delivered using all or parts of delivery network 1 (106). The content manager 110 has access to a content database 122 which serves as a repository, if not simply an access point, for content available for viewing via the media device 108.

Several adaptations for utilizing the separately delivered media item can be possible. In one possible approach, the special content is provided as an augmentation to the broadcast content, providing alternative displays, purchase and merchandising options, enhancement material, etc. In another embodiment, the special content can completely replace some programming content provided as broadcast content. Finally, the special content can be completely separate from the broadcast content, and can simply be a media alternative that the user can choose to utilize. For instance, the special content can be a library of movies that are not yet available as broadcast content. In one embodiment, media item having a long original rental period may be available from the content source as special content provided to the content manager.

The media device 108 can receive different types of content from one or both of delivery network 1 and delivery network 2. The present invention addresses delivery of special content via delivery network 2. The media device 108 processes the content, and provides such content based on user preferences and commands. The media device 108 can also include a storage device, such as a hard drive or optical disk drive, for recording and playing back audio and video content. The processed content is provided to a display device 114. The display device 114 can be a conventional 2-D type display or can alternatively be an advanced 3-D display. The display device can be a full television device, a monitor, or a display built in and associated with the media device or gateway that contains the media device.

The media device 108 can also be interfaced to a second screen such as a touch screen control device 116. The touch screen control device 116 can be adapted to provide user control for the media device 108 and/or the display device 114. The touch screen device 116 can also be capable of displaying the video and/or audio content of a media item. An example touch screen device can be a remote control, a digital tablet, a cell phone, a personal digital assistant, a personal computer, and the like. The video content displayed on the touch screen device 116 can be a representation of graphics or text entries, such as user interface entries (as discussed below), or can be all or a portion of the video and audio content that is delivered to the display device 114. The touch screen control device 116 can interface to media device 108 using any well known signal transmission system, such as infra-red (IR) or radio frequency (RF) communications and can include standard protocols such as infra-red data association (IRDA) standard, Wi-Fi, Bluetooth and the like, or any other proprietary protocols.

In the example of FIG. 1, system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 can be part of the back end server 118. In the present example of FIG. 1, the back end server 118 (as well as the usage database 120) is connected to the system 100 and accessed through the delivery network 2 (112). In an alternate embodiment, the usage database 120 and backend server 118 can be embodied in the media device 108. In a further alternate embodiment, the usage database 120 and back end server 118 can be embodied on a local area network to which the media device 108 is connected.

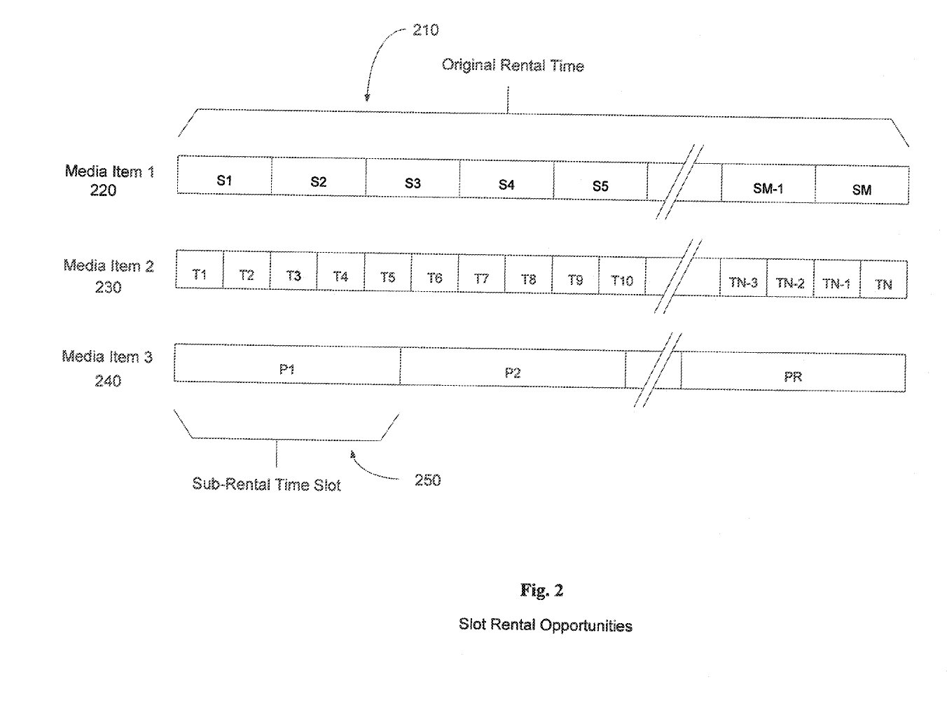

FIG. 2 illustrates example sub-rental slot rental opportunity periods within an original rental period according to aspects of the invention. One feature of the invention is that of an original rental time period or duration. An original rental time is a period of time in which a media item or asset is initially rented from a controlling entity to an initial renting entity. The controlling entity is an entity that has control over the use of the media item such as a studio, an authorized distributor, or other content source for the specific media item. An initial renting entity is an entity that rents or leases the assets that are the media items for a period of time known as the original rental time. For example, a content provider, representing the ownership interests of a studio, acts as a controlling entity by being a content provider for the media item. The controlling entity offers the media item as a rental item to an initial renting entity for an original rental time period. The original rental period is of fixed length. At the beginning of the rental period, the renter has access to the media item for the duration of the original rental period of time. During the rental period the renter has full access to the media item. At the end of the rental period, the renter relinquishes access to the media item and can no longer use the media item.

According to an aspect of the invention, the media item has a run time (full playing time duration) that is much shorter in duration than the original rental time. In one example, a three hour long movie has an original rental period of four days. During this original rental time, the initial renter may view the media item multiple times before relinquishing access to the asset back to the content source. Any form of media item can be used. Examples include movies, TV shows, documentaries, digital games, music, electronic books, and the like. Having such a long original rental period with respect to the play duration of the media item allows the original rental period renter to sub-rent the media item. In a sub-rent environment, the original rental period renter allows others to rent the media item for a time period less than that of the original rental time. Hence, multiple opportunities exist for a sub-rental of the media item. It is also assumed that only one user (sub-renter) can have viewing or playing access to the media item at a time.

FIG. 2 depicts an original rental time period 210 and sub-rental opportunities for three media items: 220, 230, and 240. There are M sub-rental time slots 220 for media item 1. Here, each rental slot is labeled S1, S2, S3, through SM. In one aspect of the invention, the duration of S slots are equal. Each duration of S allows a user of the sub-rental time slot to use the media item 1 for full play duration of the digital media item 1. Not all media items have the same full play duration. For example, media item 2 has shorter full play duration as compared to media item 1. Thus, the number of sub-rental time slots 230 for media item 2 are more in number than those of sub-rental time slots 220 for media item 1. Media item 2 has equal duration sub-rental time slots labeled as T1, T2, T3, through TN. Each sub-rental time slot duration allows a user of a sub-rental time slot in 230 to use the media item 2 for full play duration of the media item. Media item 3 has longer full play duration as compared to the full play duration time of media item 1. Thus, the sub-rental time slot 250 is longer in duration than that of the S1, S2, S3, etc. sub-rental time period durations. There are R sub-rental time slots 240 for media item 3. Here, each rental slot is labeled P1, P2, P3, through PR.

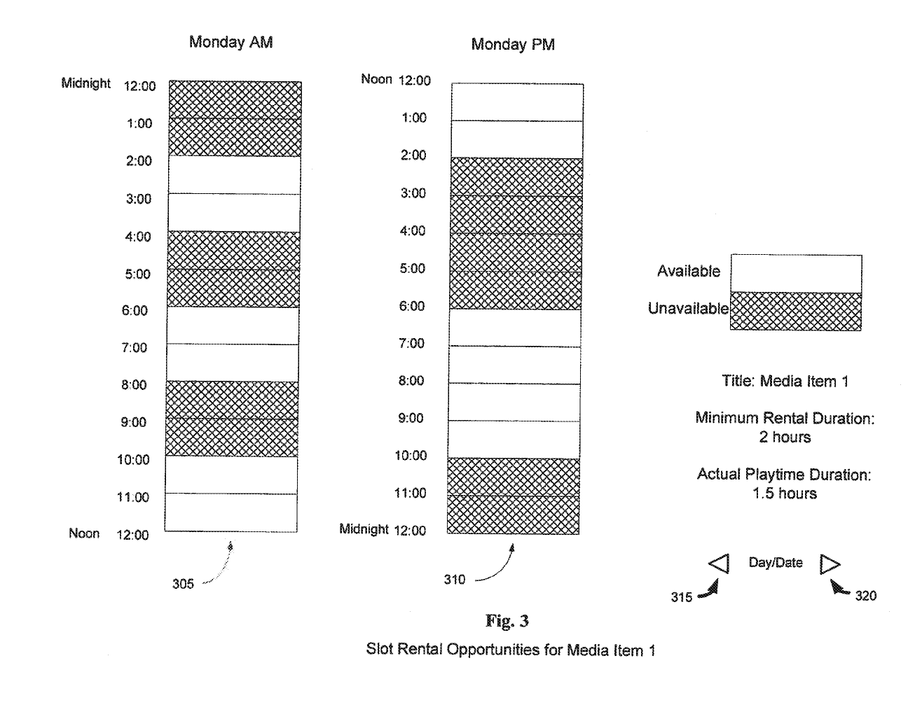

For the sake of simplicity, the original rental time 210 is shown to be the same for all three media items. However, each media item could have a different original rental time duration and/or different original rental time start and end times. This complexity in scheduling can be simplified for a user of the media device 108 of FIG. 1 when attempting to select an appropriate sub-rental time slot. FIG. 3 depicts one embodiment of a user interface graphic useful for selecting an available sub-rental time period in which to view a media item. In the graphic display depicted in FIG. 3, the sub-rental time slot opportunities for viewing or playing media item 1 are shown. Here, a user (sub-renter) is given information concerning the available sub-rental time slot opportunities.

When a user selects media item 1 to rent, then a graphic similar to that of FIG. 3 is displayed by the media device 108 on one or both of display device 114 or touch screen device 116. The graphic display of FIG. 3 displays to a potential renter which sub-rental time slots are available for playing media item 1. In one embodiment, available slots are selectable and unavailable slots are grayed-out. In other embodiments, colors or icons representing available and unavailable time slots may be used. The FIG. 3 graphic display may also include optionally include the title of the media item, the minimum Sub-Rental Duration established for the media item, and the actual playtime duration of the media item. In the specific example of FIG. 3, a user is presented with multiple two hour sub-rental time slots from which to choose. One day of sub-rental time slots are shown. A Monday AM sub-rental time slot stack 305 is shown and a Monday PM sub-rental time slot stack is shown 310. If a different day is desired, a user may use a back-facing arrow or equivalent indication 315 to choose an earlier day schedule for the media item selected. A forward-facing arrow or equivalent indication may be used to choose a later day schedule for the media item. If no time direction arrow is available, then viewing is not available in the time direction.

In the example of FIG. 3, the two hour availability limitation is imposed because the media item is 1.5 hours in playtime duration. The two hour time slot allows user to fully play or view the media item with some spare time for user viewing pauses. The grayed-out time slots represent time slots which have been selected by others who wish to rent the media item. The specific slots available in FIG. 3 are based on the demand for viewing or playing media item 1. Other media items, as shown in FIG. 2, may have different time slots of availability based on the playtime or run-time duration of the media item.

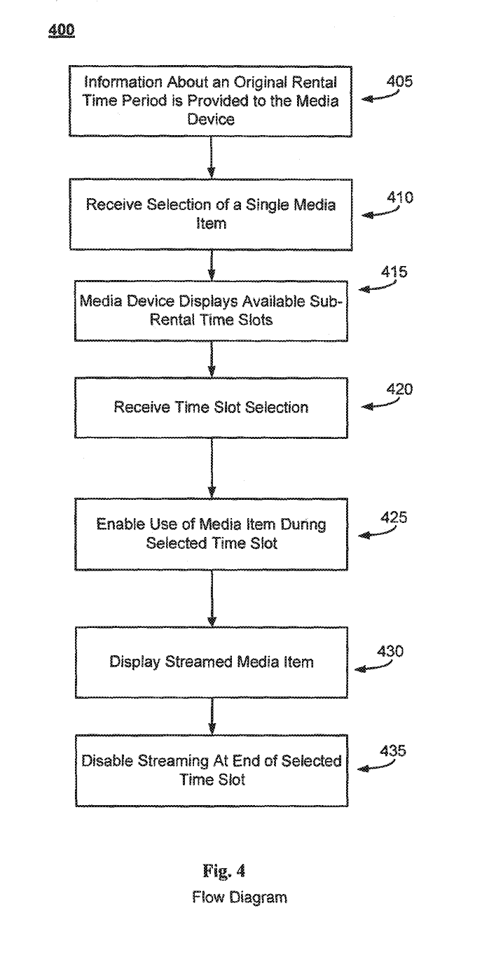

FIG. 4 is a method 400 of a typical use of the invention from the perspective of the media device 108 of FIG. 1. Initially, an original rental time period is established for a media item. Information regarding the original rental time periods for a multitude of media items are provided to the media device at step 405. This information is used by the media device 108 so that sub-rental time periods can be determined for the media items. Original rental time periods for various media items can start and stop at different times and it is expected that many original time periods for media items will overlap. Each original rental time period for each media item is independent from other media items original rental time periods.

In step 410, a user would utilize the media device 108 of FIG. 1 and interface with display device 114 and or touch screen device 116 to select a media item from a list of many media items available for rental. Typically, the user is not aware that the media item rental is a sub-rental. In one instance, the original rental period may already have started when the viewer or user of the media device starts looking for a media item to access. At step 410, the media device 108 receives a selection of which media item is to be scheduled by a user for use and viewing. Here, a display of media items is displayed to the user of the media device 108 so that she may make a selection. The results of that selection are received by the media device 108. At step 415, a display similar to that of FIG. 3 is displayed showing the user her options in selecting a time slot of suitable duration for a full viewing or playback of the selected media item. Thus, at step 415, the media device 108 drives the display device 114 or the touch screen device to show available time slots for the media item selected in step 410. In one embodiment of the present invention, a price for a sub-rental time period is also displayed. For example, a cursor placed over an available time slot, such as a time slot shown in FIG. 3, can reveal the price to a user of a media item. As described below, the price may be determined dynamically.

At step 420, the media device receives the time slot selection for the selected media item. The selected media item is generally made by a user of the media device 108 and may be received by the media device via the touch screen device 116 or other input device associated with the display device 114. A user may wish to select one time slot or multiple time slots. The selection of multiple time slots may be advantageous to the user to set up multiple viewings of the chosen media item.

With both media selection and sub-rental time slot selected, the consumer (user or sub-renter) of the selected media item waits until the selected time arrives. That is, the user or viewer waits until the beginning of the time slot that was selected to access the selected media item. Then at step 425, access to the media item is enabled via the media device 108. In a preferred embodiment, a streaming of the selected media item can begin the start of the sub-rental time slot. Streaming may be preferred to avoid the capture of the entire media item by memory of the media device if a download of the selected media item is performed. Although memory cache is used in a media device 108, the purpose of cache is to provide ready access for streaming display of multimedia information (Video and Audio) as opposed to full storage of the entire media item prior to a rendering of the media item to a display.

Step 425 enables use of the media item. Enablement of the media item includes initializing a media device to allow the user to take the action of playing the media item. Playing the media item may include playback of a multimedia video, entry to a program, entry to a game, and the like. In one embodiment, a media item to be played back is streamed to the media device. To enable streaming during the selected timeslot as in step 425, any technique may be used. For example, control methods for limiting use of the selected media item to within the sub-rented time slot include, but are not limited to: (1) allowing streaming of the rented media asset item to the user for only the rented time slot period using (a) time slot access controls on the receiving-end set-top-box or media device 108, (b) time slot access controls on the content source 102 or content manager 110 end of the media delivery scheme of FIG. 1 and/or (2) controlling the availability of playback of a downloaded media item, such as a movie, to the rented time slot by using digital rights management (DRM) techniques locally at the media device 108. As indicated above, streaming is preferable to downloading before displaying the selected media item. However, a downloading environment is also possible as an alternate embodiment. The invention concept includes any mechanism to limit the viewing of a digital movie to a specific time period for a streamed or downloaded media asset item. If the media item is a game, then a download may be preferable to a streaming technique.

At step 430, assuming the media item is a multimedia video, the display devices for the media device 108 are used to display the streamed media asset item. During this time, the user of the media device 108 may start, pause, resume, stop, forward, rewind, and perform any other playback features that can be associated with a streamed media item. The selected media item can be played or viewed during the sub-rental time slot period. At step 435, the sub-rental time slot period expires and the streaming is disabled. As discussed above, this end-of-slot time period loss of access may occur as a function of a time duration control function which disallows further streaming as monitored by the media device using time slot end time as a trigger. Alternately, the time slot time end may be monitored by the content source 102 or content manager 110. Such control may involve digital right management (DRM) techniques operating locally at the media device 108. The invention concept includes any known mechanism to limit the viewing of a media item to a specific time period for a streamed or downloaded media item.

In another aspect of the invention, pricing of the media item to a sub-renter may be a variable quantity dependent on a number of factors. For example, once rented to one person (a sub-renter), then the media item, such as a movie, may be placed on a special pricing schedule based on demand. In one instance, once rented by a particular sub-renter, then the sub-rental price may increase if demand for the sub-rental media item increases. This is based on supply and demand, where high demand on a limited resource drives the sub-rental price up for subsequent sub-renters. Alternately, if the demand for the media item is low, then the price for a sub-rental of the media item may be lower to entice would-be sub-renters to accept a sub-rental time slot.

In another aspect of variable pricing, the media item may be offered at a price that is indicative of “on prime time” versus “off prime time” schedules. For example, in a given geographic market, if a media item available for sub-rental is popular, then “on prime time” sub-rental may be priced higher due to the higher demand in prime time hours, such as between 7:00 P.M. and 10:00 P.M. in the local time zone market. Alternately, the same media item may be offered at a discounted price in “off prime time” hours so that the media item can be sub-rented more often during hours of lower demand.

In another pricing scenario, multiple sub-rentals by an individual viewer of a single media item may be encouraged by offering discounts for multiple viewings. This encourages a viewer to not only sub-rent the media item to complete an initial viewing of the item, but also encourages a viewer to repeat a sub-rental to enjoy the media item again at a lower price. In another option, multiple sub-rental viewings of a media item by an individual viewer may trigger a rent-to-own offer option, where a particular number of repeat views may entice the particular viewer to continue repeat sub-rental viewings in order to eventually own the media item. Pricing of a media item in the sub-rental arrangement of the present invention may be dynamic based on one or more factors including the popularity of the media item, the availability of the media item, a sub-rental time period compared to a prime-time period, and a rent-to-own offer option of the media item.

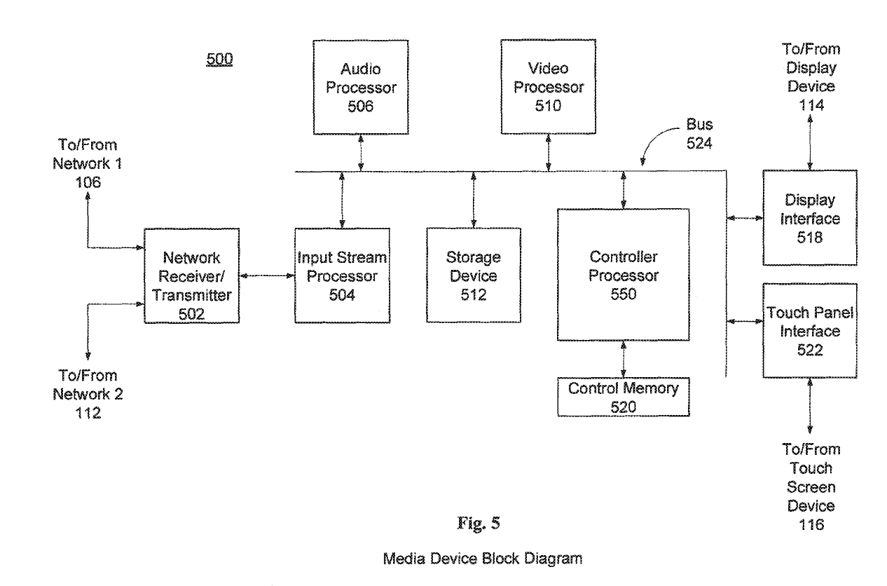

Turning now to FIG. 5, a block diagram of an embodiment of a media device 500 is shown. Media device 500 can operate similar to the media device 108 described in FIG. 1 and can be included as part of a gateway device, modem, set-top box, computer, hand held device, or other similar communications device. The media device 500 shown can also be incorporated into other systems including an audio device and/or a display device. In either case, several components necessary for complete operation of the system (e.g. power supply, internal connections, some interfaces, etc.) are not shown in the interest of conciseness, as they are well known to those skilled in the art. In one exemplary embodiment, media device 500 can be a set-top box coupled to a display device (e.g. television). In another embodiment, the media device can be a hand-held (e.g. mobile) unit with an integrated display device or a unit with a fixed location (local or remote) display device that allows playback of media files.

The media device of FIG. 5 may be used as one example environment useful to perform the method discussed above with respect to FIG. 4. In the media device 500 shown in FIG. 5, the content is received by a network receiver/transmitter 502. The network receiver/transmitter 502 can be one of several known receiver circuits used for receiving, demodulating, and decoding signals provided over one of the several possible networks including over the air, cable, satellite, Ethernet, fiber, and phone line networks. The desired input signal can be selected and retrieved by the network receiver/transmitter 502 based on user input provided through a control interface or touch panel interface 522. Touch panel interface 522 can include an interface for a touch screen device. Touch panel interface 522 can also be adapted to interface to a cellular phone, a tablet, a mouse, a high end remote or the like. In one set of interface embodiments, touch panel interface 522 can be a wired or wireless interface. Wireless interfaces can include any over-the-air interfaces, such as an RF interface or IR interface, Bluetooth™, and a protocol based interface such as IEEE 802.11.

In one embodiment, one or more digital busses 524 interconnect the controller/processor 550 with other functional blocks. One of skill in the art recognizes that non-bus-oriented topologies are also possible implementations of the media device 500. Blocks that have a bus 524 interface with the processor 550 include input stream processor 504, storage device 512, audio processor 506, video processor 510, display interface 518, and touch panel interface 522.

The decoded output signal of network receiver/transmitter 502 is provided to an input stream processor 504. The input stream processor 504 performs the final signal selection and processing, and includes separation of video content from audio content for the content stream of either network input 106 or 112. The audio content is provided to an audio processor 506 for conversion from the received format, such as compressed digital signal, to an analog waveform signal or equivalent digital audio for use by an output device, such as a display 114 or a touch screen device 116. In one embodiment, a digital audio signal from audio processor 506 can be used to drive a display device using a High-Definition Multimedia Interface (HDMI) cable or alternate audio interface such as via a Sony/Philips Digital Interconnect Format (SPDIF) (not shown). One version of audio interface can also include amplifiers for driving one more sets of speakers. The audio processor 506 also performs any necessary conversion for the storage of the audio signals.

The video output from the input stream processor 504 is provided to a video processor 510 via a bus 524. The video signal can be one of several formats. The video processor 510 provides, as necessary, a conversion of the video content, based on the input signal format. The video processor 510 also performs any necessary conversion for the storage of the video signals.

A storage device 512 stores audio and video content received at the input. The storage device 512 allows later retrieval and playback of the content under the control of a controller 550 and also based on commands, e.g., navigation instructions such as fast-forward (FF) and rewind (RW), received from a user interface (not shown) and/or touch panel interface 522. The storage device 512 can be a hard disk drive, one or more large capacity integrated electronic memories, such as static RAM (SRAM), or dynamic RAM (DRAM), or can be an interchangeable optical disk storage system such as a compact disk (CD) drive or digital video disk (DVD) drive.

The converted video signal, from the video processor 510, either originating from the input or from the storage device 512, is provided to the display interface 518. The display interface 518 further provides the display signal to a display device of the type described above. The display interface 518 can be an analog signal interface such as red-green-blue (RGB) or can be a digital interface such as HDMI. Display drivers for driving a touch panel may be located in many locations of the media device as is well known in the art. For example, display drivers for a touch panel may be located in the touch panel interface 522, the control memory 520, the controller 550, or the video processor 510. Likewise, display drivers for driving an internal or external display device may be located in the display interface 518, the control memory 520, the controller 550, or the video processor 510.

In one embodiment, the controller 550 coordinates calculation and presentation of a display of the time slot scheduling for the sub-rental time periods such as that shown in FIG. 3 for a selected media item. The controller 550 may also coordinate the start and stop time access controls for the selected media item. Alternately, such controls may be via communications with the content manager 110 via network 2 or control of an internal timer set by the content manager. Alternately, a DRM control to limit access to the selected time slot for the media item may be managed by the controller 550. The controller 550 also manages the conversion process for converting the input stream signal into a signal for storage on the storage device or for display. Such conversion may also be provided by the video processor 510. Equivalently, a graphics processor unit (GPU), not specifically shown, may be used to process video. The controller 550 also manages the retrieval and playback of stored content. In one embodiment, the controller 550 provides pricing information for display. The pricing information is determined dynamically as described above with respect to the method 200 of FIG. 4. Pricing information may be obtained from information acquired from the back end server 118 of FIG. 1 or may be calculated locally by the controller 550.

The controller 550 is further coupled to control memory 520 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 550. Control memory 520 can store program code or other control instructions for controller 550. Control memory 520 can also store code relating to a display of the sub-rental opportunities as shown in FIG. 3. Further, the implementation of the control memory 520 can include several possible embodiments, such as a single memory device or, alternatively, more than one memory circuit communicatively connected or coupled together to form a shared or common memory with other devices (interconnections not shown). Still further, the memory can be included with other circuitry, such as portions of bus communications circuitry, in a larger circuit.

Controller 550 coordinates many of the events relating to the flow diagram of FIG. 4. For example, the controller/processor 550 coordinates the reception of a plurality of original rental time slot periods for a plurality of media items. The display of media items to a user via a driver and display and the selection of a media item for sub-rental via an output display and input selection interface (such as the touch panel interface) is coordinated using controller/processor 550. Controller/processor 550 also controls or coordinates the enabling of access to the selected media item where the start and stop times for access are controlled dependent on the selected time slot for a selected media item. Controller/processor 550 also coordinates driving a display useful for media item selection, display of time slots for viewing, and enforcement of start and stop times, as well as other viewing controls such as pause, play, rewind, fast forward, etc. In one embodiment, the controller/processor, video processor, and audio processor are co-located as one unit.

Optionally, controller 550 can be adapted to extract metadata, criteria, characteristics or the like from audio and video media by using audio processor 506 and video processor 510, respectively. That is, metadata, criteria, characteristics or the like that is contained in the vertical blanking interval, auxiliary data fields associated with video, or in other areas in the video signal can be harvested by using the video processor 510 with controller 550 to generate metadata that can be used for functions such as generating an electronic program guide having descriptive information about received video, supporting an auxiliary information service, and the like. Similarly, the audio processor 506 working with controller 550 can be adapted to recognize audio or video watermarks that can be in an audio or video signal. Such audio or video watermarks can then be used to perform some action such as the recognition of the audio or video signal, provide security which identifies the source of an audio or video signal, or perform some other service. Furthermore, metadata, criteria, characteristics or the like, to support the actions listed above can come from a network source which are processed by controller 550.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus, hardware and software apparatus. An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device.

Additionally, the methods may be implemented by instructions being performed by a processor, and such instructions may be stored on a processor or computer-readable media such as, for example, an integrated circuit, a software carrier or other storage device such as, for example, a hard disk, a compact diskette (“CD” or “DVD”), a random access memory (“RAM”), a read-only memory (“ROM”) or any other magnetic, optical, or solid state media. The instructions may form an application program tangibly embodied on a computer-readable medium such as any of the media listed above or known to those of skill in the art.

1. A method of displaying a media item, the method comprising:
receiving information concerning original rental time periods for a plurality of media items;
receiving a selection of one of the plurality of media items;
displaying sub-rental time slots within an original rental time period for the selected media item;
receiving a selection of a sub-rental time slot;
enabling online access to the selected media item in the selected sub-rental time slot;
displaying the selected media item during the selected sub-rental time slot.

2. The method of claim 1, further comprising:
disabling access to the media item at the end of the selected sub-rental time slot.

3. The method of claim 1, wherein receiving information concerning original rental time periods comprises receiving different start and stop times for the plurality of media items.

4. The method of claim 1, wherein receiving a selection of one of the plurality of media items comprises receiving, by a media device, a user selection of one of the plurality of media items.

5. The method of claim 1, wherein displaying sub-rental time slots comprises displaying a graphic on a user interface showing available periods of time for sub-rental of the selected media item.

6. The method of claim 1, wherein displaying sub-rental time slots within an original rental time period for the selected media item further comprises displaying a price for rental of the selected media item for a particular time slot.

7. The method of claim 6, wherein the price displayed is determined dynamically.

8. The method of claim 7, wherein factors affecting the dynamically determined price comprise one or more of a popularity of the selected media item, the availability of the selected media item, a sub-rental time period compared to a prime-time period, and a rent-to-own offer of the selected media item.

9. The method of claim 1, wherein receiving a selection of a sub-rental time slot comprises receiving an input from a user interface for a future time period in which to access the selected media item.

10. The method of claim 1, wherein enabling access to the selected media item in the selected sub-rental time slot comprises allowing a media device to stream the selected media item for user viewing during the selected sub-rental time slot.

11. The method of claim 1, wherein displaying the media item during the selected sub-rental time slot comprises providing display access to the selected media item via a display device wherein a user may start, pause, resume, and stop streaming of the media item to the media device.

12. An apparatus for displaying a media item, the apparatus comprising:
a receiver for receiving information concerning original rental time periods for a plurality of media items;
an interface for receiving a selection of one of the plurality of media items;
a processor, connected to memory, the processor coordinating driving a display of sub-rental time slots within an original rental time period for the selected media item, and receiving a selection of a sub-rental time slot;
wherein the processor coordinates access to the selected media item in the selected sub-rental time slot and display of the selected media item during the selected sub-rental time slot.

13. The apparatus of claim 12, wherein the receiver for receiving information concerning original rental time periods comprises a network interface receiver.

14. The apparatus of claim 12, wherein the interface for receiving a selection of one of the plurality of media items is a touch panel display interface.

15. The apparatus of claim 14, wherein the touch panel display interface allows a user control of display of the selected media item.

16. The apparatus of claim 15, wherein the user control of the display includes start, pause, resume, and stop of play of the selected media item.

17. The apparatus of claim 12, wherein the processor further comprises a video and audio processor.

18. The apparatus of claim 12, wherein the processor coordinates streaming of the selected media item during a time period corresponding to the selected sub-rental time slot.

19. The apparatus of claim 12, wherein the processor further provides pricing information for display with regard to a sub-rental time slot.

20. The apparatus of claim 19, wherein the pricing information is determined dynamically.
